(19) United States
(12) Patent Application Publication
(10) Pub. No.: US 2021/0210829 A1
(43) Pub. Date: Jul. 8, 2021

(54) DIELECTRIC WAVEGUIDE FILTER

(71) Applicant: SAMSUNG ELECTRONICS CO., LTD., Suwon-si (KR)

(72) Inventors: Ruoming WANG, Shenzhen (CN); Haiju KANG, Shenzhen (CN); Zhenkun ZHANG, Shenzhen (CN); Bingjian NIU, Shenzhen (CN)

(73) Assignee: SAMSUNG ELECTRONICS CO., LTD., Suwon-si (KR)

(21) Appl. No.: 17/059,123

(22) PCT Filed: Dec. 27, 2018
(86) PCT No.: PCT/KR2018/016772

§ 371 Date: Nov. 25, 2020

(30) Foreign Application Priority Data
Jun. 5, 2018 (CN) 201810567364.6

(51) Int. Cl. H01P 1/20; H01P 1/08

(52) U.S. Cl. CPC H01P 1/2002; H01P 1/08

(57) ABSTRACT

The disclosure discloses a dielectric waveguide filter, comprising a plurality of first resonant cavities, each two of which are connected to form upper resonant cavities and a plurality of second resonant cavities, each two of which are connected to form lower resonant cavities, wherein the upper resonant cavities and the lower resonant cavities are correspondingly overlapped; each first resonant cavity has a first window coupling structure, wherein the first window coupling structure comprises: at least one of a first window opened at a position where the magnetic field distribution of a high-order mode in the first resonant cavity is the weakest, and a second window opened at a position where the electric field distribution of the high-order mode in the first resonant cavity is the strongest; and each second resonant cavity has a second window coupling structure corresponding to the first window coupling structure.

### TECHNICAL FIELD

The disclosure relates to the field of filters, in particular to a dielectric waveguide filter.

### BACKGROUND ART

With the rapid development of wireless mobile communication technology, the requirements for the far-end out-of-band performance of dielectric waveguide filters have become increasing. However, current dielectric waveguide filters inevitably have a problem of poor suppression and near harmonics in the high-order mode frequency band, usually 1.3 times the frequency. In order to solve the problem, it is usually necessary to use multi-order low-pass filters to suppress high-order modes of the far-end out-of-band, and the additional low-pass filters increase area and insertion loss.

In order to further improve far-end suppression, cascading of a dielectric waveguide filter and a metal cavity may also be adopted. A harmonic of the far-end of the metal cavity is good, cascading of the metal cavity and the dielectric waveguide filter may improve the far-end suppression, however, the metal cavity occupies a large area, that causes it is difficult to achieve the same volume as the dielectric waveguide filter by the cascading manner.

In addition, a TEM (Transverse Electric and Magnetic Field) mode can also be used to improve the far-end suppression. The harmonic of the TEM mode is farther than that of a dielectric waveguide, but a Q value thereof is lower than that of the dielectric waveguide, and the performance thereof is poorer than that of the dielectric waveguide.

### DISCLOSURE OF INVENTION

### Technical Problem

The disclosure aims to provide a dielectric waveguide filter, and the far-end harmonic suppression and high-order mode frequency band suppression of the dielectric waveguide filter are improved by providing coupling structures aiming at high-order modes.

### Solution to Problem

In order to achieve the object above, the present disclosure provides a dielectric waveguide filter, comprising:

a plurality of first resonant cavities and a plurality of second resonant cavities, wherein each two of the plurality of first resonant cavities are connected to form upper resonant cavities, each two of the plurality of second resonant cavities are connected to form lower resonant cavities, and the upper resonant cavities and the lower resonant cavities are correspondingly overlapped;

each first resonant cavity has a first window coupling structure, wherein the first window coupling structure comprises: a first window opened in the surface of the first resonant cavity at a position where the magnetic field distribution of a first high-order mode in the first resonant cavity is the weakest, and/or a second window opened in the surface of the first resonant cavity at a position where the electric field distribution of the first high-order mode in the first resonant cavity is the strongest;

each second resonant cavity has a second window coupling structure corresponding to the first window coupling structure, wherein the second window coupling structure comprises: a third window opened in the surface of the second resonant cavity at a position where the magnetic field distribution of a first high-order mode in the second resonant cavity is the weakest, and/or a fourth window opened in the surface of the second resonant cavity at a position where the electric field distribution of the first high-order mode in the second resonant cavity is the strongest; and

the first window coupling structure and the second window coupling structure cooperate to eliminate coupling between the first high-order mode in the first resonant cavity and the first high-order mode in the second resonant cavity.

Preferably, the first window and the second window are located on a side surface, opposite to the second resonant cavity, of the first resonant cavity, and

the third window and the fourth window are located on a side surface, opposite to the first resonant cavity, of the second resonant cavity.

Preferably, the first window is located at a center of a pair of opposite sides of the first resonant cavity, and the third window is located at a center of a pair of opposite sides of the second resonant cavity; and

the second window is flush with a center of the first resonant cavity and is ¼ of a side length away from the center of the first resonant cavity, and the fourth window is flush with a center of the second resonant cavity and is ¼ of a side length away from the center of the second resonant cavity.

Preferably, the dielectric waveguide filter further comprises a feed structure for reducing the excitation of a second high-order mode, wherein the feed structure comprises:

protrusions protruding from one side edge of the first resonant cavity or the second resonant cavity to the outside of the cavity; and

feed posts arranged at the junctions of the first resonant cavity or the second resonant cavity and the protrusions.

Preferably, the protrusions include:

a first protrusion protruding from one side edge of the first resonant cavity as an input cavity to the outside of the cavity; and

a second protrusion, protruding from one side edge of the second resonant cavity as an output cavity to the outside of the cavity.

Preferably, the dielectric waveguide filter further comprises:

a adjacent cavity coupling spacer, connected between two adjacent first resonant cavities or between two adjacent second resonant cavities,

wherein the adjacent cavity coupling spacer is located at the center of a pair of opposite sides of the two first resonant cavities or the two second resonant cavities, to reduce the coupling of the first high-order modes and the second high-order modes between the two adjacent first resonant cavities or between the two adjacent second resonant cavities.

Preferably, the adjacent cavity coupling spacer does not coincide with the first windows or the third windows in position.

Preferably, the plurality of first resonant cavities are arranged in a center symmetric or axisymmetric manner to form the upper resonant cavities, and

the plurality of second resonant cavities are arranged in the same manner as the arrangement of the upper resonant cavities to form the lower resonant cavities.

### Advantageous Effects of Invention

As can be seen from the technical scheme above, the disclosure has the beneficial effects that:

(1) the window coupling structures aiming at first high-order modes are set in the dielectric waveguide filter of the present disclosure, and the first window coupling structures in the upper resonant cavities and the second window coupling structures in the lower resonant cavities are coupled to each other, reducing the inter-cavity coupling of the first high-order modes of the two resonant cavities connected between two adjacent layers, so as to realize the suppression of the first high-order modes;

wherein, the first window and the third window are both located at the positions where the corresponding main mode magnetic field distribution is the strongest and the corresponding first high-order mode magnetic field distribution is the weakest, thus the magnetic coupling between the first high-order modes is minimized while ensuring main mode coupling; meanwhile, the coupling between the second window and the fourth window corresponding to the positions where the electric field distribution of the first high-order modes is the strongest forms electrical coupling, which increases the electrical coupling between the first high-order modes, thereby counteracting the magnetic coupling formed between the first window and the third window, which further reducing the inter-cavity coupling of the first high-order modes, inhibiting the transmission of the first high-order modes, and thus achieving the purpose of improving the suppression of the first high-order modes by the filter;

(2) the feed structure of the present disclosure reduces the excitation of the second high-order modes B from the source, thereby increasing the suppression of the second high-order modes B;

(3) the coupling spacer of two adjacent resonant cavities in the same layer may reduce the coupling between the first high-order modes and the second high-order modes of the two resonant cavities; and

(4) the combination of the window coupling structures, the feed structure and the adjacent cavity coupling spacer may cut off multiple groups of coupling paths between two high-order modes closest to the fundamental mode frequency, i.e. the coupling between the high-order modes is reduced, thus comprehensively improving the suppression of the high-order modes by the dielectric waveguide filter.

### BRIEF DESCRIPTION OF DRAWINGS

FIG. 1a is a top view of a resonant cavity of a dielectric waveguide filter of an embodiment of the present disclosure;

FIG. 1b is a partial side view of a dielectric waveguide filter according to various embodiments of the present disclosure;

FIG. 2a to FIG. 2c are electric field distribution diagrams of a first high-order mode, a second high-order mode and a fundamental mode in a resonant cavity of a dielectric waveguide filter according to various embodiments of the present disclosure;

FIG. 3 is a top view of a resonant cavity of a dielectric waveguide filter of another embodiment of the present disclosure;

FIG. 4 is a schematic diagram illustrating a connection structure of two resonant cavities of a dielectric waveguide filter according to various embodiments of the present disclosure;

FIG. 5 is a top view of a dielectric waveguide filter of an embodiment of the present disclosure;

FIG. 6 is an oscillogram of a dielectric waveguide filter according to various embodiments of the present disclosure;

FIG. 7 is a structure schematic diagram of four layers of resonant cavities of a dielectric waveguide filter of a specific embodiment of the present disclosure.

### MODE FOR THE INVENTION

In order to make the purpose, technical scheme and advantages of the present disclosure clearer, some embodiments of the present disclosure will be described in detail below with reference to the accompanying drawings. It should be understood that the embodiments described herein are only for the purpose of explaining the present disclosure and are not intended to limit the present disclosure.

The disclosure aims to provide a dielectric waveguide filter, and the far-end harmonic suppression of the dielectric waveguide filter and the suppression frequency range are increased by providing coupling structures aiming at high-order modes.

It should be noted that, each first resonant cavity 10 has its own first high-order mode and second high-order mode, and the first high-order mode and second high-order mode of each first resonant cavity 10 refer to two high-order modes closest to the frequency of its own fundamental mode. Similarly, each second resonant cavity 20 has its own first high-order mode and second high-order mode, and the first high-order mode and second high-order mode of each second resonant cavity 20 refer to the two high-order modes closest to the frequency of its own fundamental mode.

In order to clearly explain the technical scheme of the present application, a plurality of first resonant cavities 10 and a plurality of second resonant cavities 20 have the same structure and shape herein, so the first high-order modes herein are all the same and the second high-order modes herein are all the same, while the first high-order modes A and the second high-order modes B are two different high-order modes. Of course, the present disclosure does not restrict whether the first resonant cavities 10 and the second resonant cavities 20 of the dielectric waveguide filter have the same structure and shape, and whether the first high-order modes and the second high-order modes are the same.

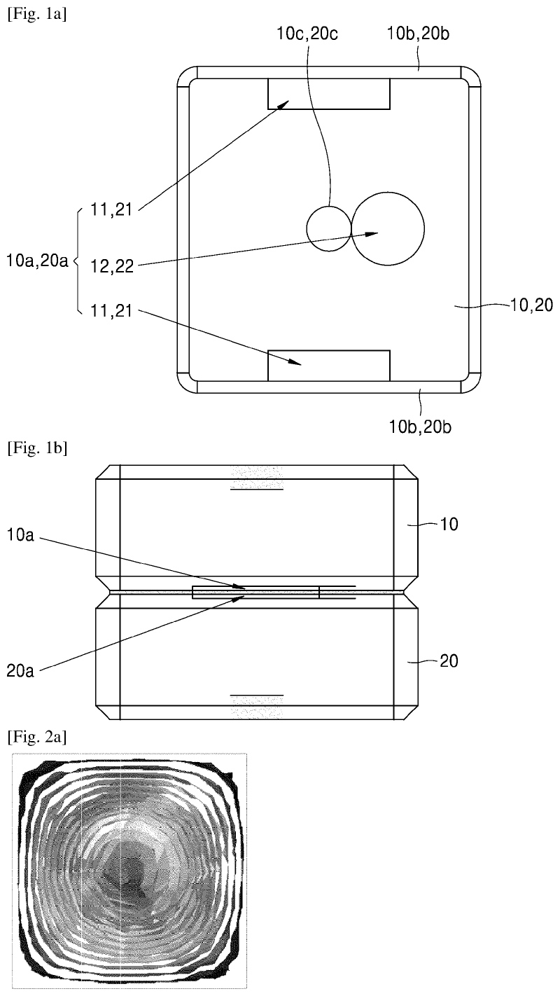

As shown in FIG. 1a and FIG. 1b, the present disclosure provides a dielectric waveguide filter, comprising:

a plurality of first resonant cavities 10 and a plurality of second resonant cavities 20, wherein each two of the plurality of first resonant cavities 10 are connected with each other to form upper resonant cavities, each two of the plurality of second resonant cavities 20 are connected with each other to form lower resonant cavities, the upper resonant cavities and the lower resonant cavities are correspondingly overlapped, and each first resonant cavity 10 and each second resonant cavity 20 have the same structure and shape. Only one first resonant cavity 10 and one second resonant cavity 20 corresponding to each other are shown in FIG. 1a and FIG. 1b.

Wherein, each first resonant cavity 10 is provided with a first window coupling structure 10a, wherein the first window coupling structure 10a comprises: a first window 11 opened in the surface of the first resonant cavity 10 at a position where the magnetic field distribution of a first high-order mode A in the first resonant cavity 10 is the weakest and the magnetic field of a fundamental mode is the strongest, and/or a second window 12 opened in the surface of the first resonant cavity 10 at a position where the electric field distribution of the first high-order mode A in the first resonant cavity 10 is the strongest;

each second resonant cavity 20 is provided with a second window coupling structure 20a corresponding to the first window coupling structure 10a, wherein, the second window coupling structure 20a comprises: a third window 21 opened in the surface of the second resonant cavity 20 at a position where the magnetic field distribution of a first high-order mode A in the second resonant cavity 20 is the weakest and the magnetic field of a fundamental mode is the strongest, and/or a fourth window 22 opened in the surface of the second resonant cavity 20 at a position where the electric field distribution of the first high-order mode A in the second resonant cavity 20 is the strongest;

wherein, the first window coupling structure 10a and the second window coupling structure 20a cooperate to eliminate coupling between the first high-order mode A in the first resonant cavity 10 and the first high-order mode A in the second resonant cavity 20.

In the present embodiment, each resonant cavity of the dielectric waveguide filter has the same structure and shape, and is solid cavity filled with a dielectric such as ceramic, and the surface of each solid cavity is covered with an electromagnetic shielding layer such as a metal layer. In general, each resonant cavity is rectangular or square, thus reducing the coupling of high-order modes in the cavity by a symmetrical structure.

The laminated structure of the upper and lower resonant cavities may isolate the high-order mode in the upper resonant cavities and the high-order mode of the lower resonant cavities, thereby reducing the coupling of the high-order modes between different cavities and realizing the suppression of the high-order modes.

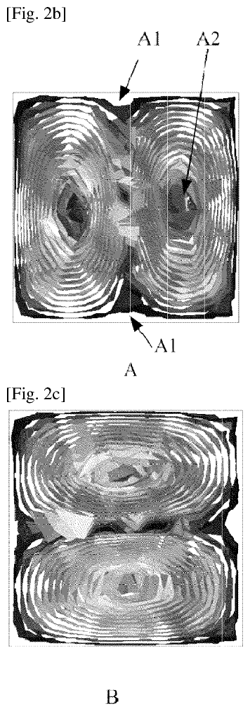

FIG. 2a to FIG. 2c show electric field distribution diagrams of a first high-order mode A and a second high-order mode B and a fundamental mode in each resonant cavity respectively. It can be seen from the figures that the first high-order modes A and the second high-order modes B are two different high-order modes in a specific embodiment, which can be seen as two different high-order modes with approximately perpendicular directions. The two modes are illustrated herein as mutually perpendicular only, but the case that the first high-order modes A and the second high-order modes B are not perpendicular to each other is not excluded.

In the dielectric waveguide filter of the present embodiment, the window coupling structures aiming at the first high-order modes A are set, and the window coupling structures consist of first window coupling structures 10a arranged in each first resonant cavity 10 and second window coupling structures 20a arranged in the corresponding second resonant cavities 20.

The coupling, between first windows 11 and third windows 21 which are arranged at the positions where the magnetic field distribution in FIG. 2b is the weakest (A1) and the magnetic field of the fundamental modes is the strongest, forms magnetic coupling to reduce the magnetic coupling between the first high-order modes A of the upper resonant cavities and the lower resonant cavities while ensuring the coupling of the fundamental modes.

The coupling, between second windows 12 and fourth windows 22 corresponding to the positions where the electric field distribution in FIG. 2 is the strongest (A2), increases the electrical coupling between the first high-order modes A, thereby counteracting the magnetic coupling formed between the first windows 11 and the third windows 21, further reducing the inter-cavity coupling of the first high-order modes A, inhibiting the transmission of the first high-order modes A, and thus achieving the purpose of improving the suppression of the first high-order modes A by the filter.

In the present embodiment, strong coupling is formed between the first windows 11 and the third windows 21 which are arranged in pairs, and between the second windows 12 and the fourth windows 22 which are arranged in pairs, thereby realizing the effect of reducing high-order mode coupling. Further, since the positions of the first window coupling structures 10a and the second window coupling structures 20a correspond to the positions of the electric field and magnetic field distribution intensity of the first high-order modes A, the coupling of the first high-order modes A may be reduced in a targeted manner.

Further, as shown in FIG. 1b, the first window 11 and the second window 12 are located on the side surface, opposite to the second resonant cavity 20, of the first resonant cavity 10, and the third window 21 and the fourth window 22 are located on the side surface, opposite to the first resonant cavity 10, of the second resonant cavity 20. The respective windows of the first window coupling structures 10a and the second window coupling structures 20a correspond to each other and face each other, thereby forming electrical coupling or magnetic coupling between the upper resonant cavities and the lower resonant cavities.

The windows of the first window coupling structures 10a and the second window coupling structures 20a herein refer to openings in the electromagnetic shielding layer on the surface of each cavity.

In particular, as shown in FIG. 2b and FIG. 1a, the first window 11 is located at a center of a pair of opposite sides 10b of the first resonant cavity 10, and the third window 21 is located at a center of a pair of opposite sides 20b of the second resonant cavity 20; and

the second window 12 is flush with a center 10c of the first resonant cavity 10 and is ¼ of a side length away from the center 10c of the first resonant cavity 10, and the fourth window 22 is flush with a center 20c of the second resonant cavity 20 and is ¼ of a side length away from the center of the second resonant cavity 20.

As can be seen from the above-described specific embodiment, by arranging the first window coupling structures 10a and the second window coupling structures 20a corresponding to each other in front of the resonant cavities between adjacent layers, the coupling between the first high-order modes A between two resonant cavities connected between adjacent layers may be reduced.

The structure of the first resonant cavity 10 and the second resonant cavity 20 serving as an intermediate resonant cavity has been specifically described above. However, if the first resonant cavity 10 or the second resonant cavity 20 is located at the outermost layer and is connected to the input end of the dielectric waveguide filter, as a head resonant cavity or connected to the output end of the dielectric waveguide filter, as a tail resonant cavity, the structure of the first resonant cavity 10 or the second resonant cavity 20 may be further optimized.

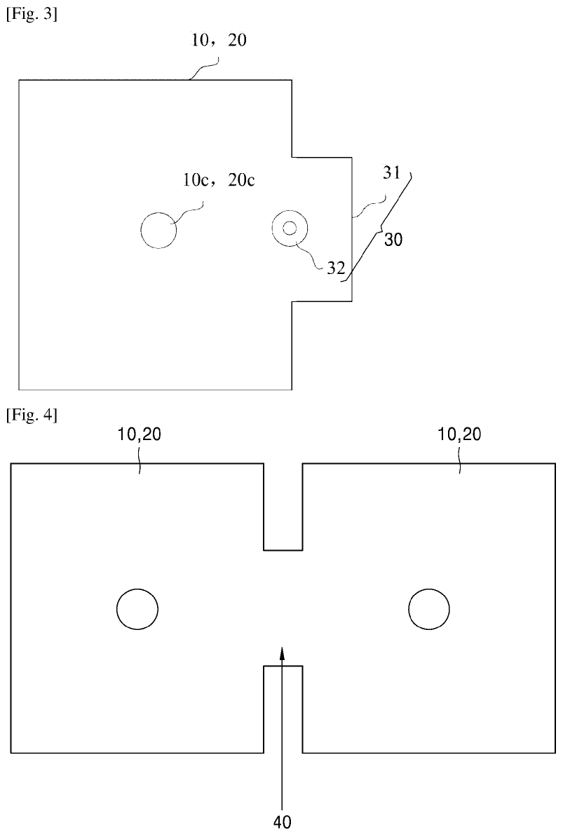

Specifically, as shown in FIG. 3, the dielectric waveguide filter of the disclosure further comprises a feed structure 30 for reducing the excitation of the second high-order modes B, wherein the feed structure 30 comprises:

protrusions 31, the protrusions 31 protrude from one side edge of the first resonant cavity 10 or the second resonant cavity 20 to the outside of the cavity; and

feed posts 32, the feed posts are arranged at the junctions of the first resonant cavity 10 or the second resonant cavity 20 and the protrusions 31.

The protrusions 31 protrude toward the outside of the cavity to adjust the coupling amount of the cavity, and the combination of the protrusions 31 with the feed posts 32 may reduce the excitation of the second high-order modes B. As can be seen from FIG. 2c and FIG. 3, the positions of the feed posts 32 correspond to the positions where the electric field distribution of the second high-order modes B is the weakest, so that the excitation of the second high-order modes B can be reduced.

In the present embodiment, the first resonant cavity 10 or the second resonant cavity 20 described above serves as the head resonant cavity or the tail resonant cavity, so that when the feed structure 30 is arranged in the head resonant cavity and/or the tail resonant cavity, the excitation of the second high-order modes B may be reduced from the source, thereby increasing the suppression of the second high-order modes B.

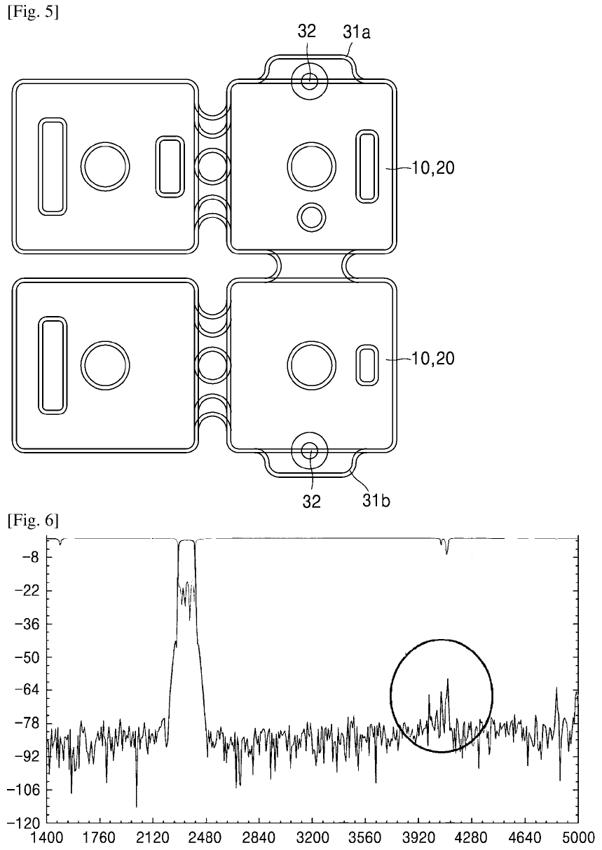

Specifically, as shown in FIG. 3 and FIG. 5, the protrusions 31 include:

a first protrusion 31a, the first protrusion 31a protrudes from one side edge of the first resonant cavity 10 as an input cavity to the outside of the cavity; and

a second protrusion 31b, the second protrusion 31b protrudes from one side edge of the second resonant cavity 20 as an output cavity to the outside of the cavity.

In a specific embodiment shown in FIG. 5, the dielectric waveguide filter is provided with eight resonant cavities, including four first resonant cavities 10 as upper resonant cavities and four second resonant cavities 20 as lower resonant cavities. Among the eight resonant cavities, a first resonant cavity 10 in the upper resonant cavities is used as the input cavity and a second resonant cavity 20 in the lower resonant cavities is used as the output cavity. Accordingly, the first protrusion 31a is arranged in the first resonant cavity 10 serving as the input cavity and the second protrusion 31b is arranged in the second resonant cavity 20 serving as the output cavity. The feed posts 32 are arranged in dielectric cavities and may allow feeding structures between the upper resonant cavities and the lower resonant cavities to be connected by penetrating through the upper and lower surfaces of the dielectric cavities, and the feeding structures between two adjacent resonant cavities may be connected through a connecting structure so as to form a through feeding structure from the input cavity to the output cavity.

Further, the plurality of first resonant cavities 10 are arranged in a center symmetric or axisymmetric manner to form the upper resonant cavities, and the plurality of second resonant cavities 20 are arranged in the same manner as the arrangement of the upper resonant cavities to form the lower resonant cavities. Structural symmetry may reduce the coupling of the first high-order mode A and the second high-order mode B in the same resonant cavity, so as to further improve the far-end suppression effect.

In order to eliminate the coupling of high-order modes more effectively, the structure of two connected adjacent resonant cavities in the same layer may also be optimized.

As shown in FIG. 4, the dielectric waveguide filter further comprises:

adjacent cavity coupling spacer 40, the adjacent cavity coupling spacer 40 is connected between two adjacent resonant cavities in the same layer. In a specific embodiment, the adjacent cavity coupling spacer 40 is connected between two adjacent first resonant cavities 10 or between two adjacent second resonant cavities 20, the adjacent cavity coupling spacer 40 is located at the center of a pair of opposite sides 10d or 20d of the two first resonant cavities 10 or the two second resonant cavities 20, to reduce the coupling of the first high-order modes A and the second high-order modes B between the two adjacent first resonant cavities 10 or between the two adjacent second resonant cavities 20.

Wherein, the adjacent cavity coupling spacer bars 40 do not coincide with the first window 11 or the third window 21 in position, that is, the side edges set by the adjacent cavity coupling spacer 40 are different from the pair of side edges set by the first windows 11 and the third windows 21.

According to FIG. 6, in an embodiment of the dielectric waveguide filter constructed according to the embodiment above, the circled high-order mode harmonics are suppressed, thereby pushing the harmonic frequency of the dielectric waveguide filter from 1.3 to 2.1 times the frequency.

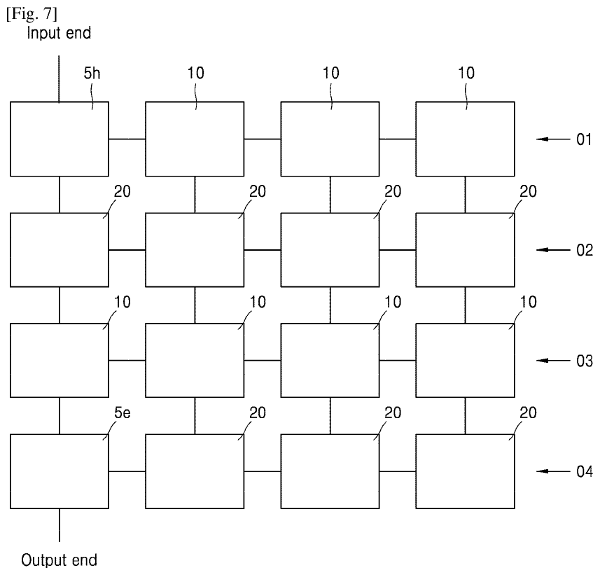

Depending on the specific form of the dielectric waveguide filter, one, two, or three of the window coupling structures formed by the first window coupling structures 10a and the second window coupling structures 20a, the feed structure 30, and the adjacent cavity coupling spacer 40 may be set selectively. For a dielectric waveguide filter with multiple layers of resonant cavities, the different structures in the embodiments above may be arranged on the resonant cavities at different positions at the same time, and for the entire dielectric waveguide filter, the coupling of high-order modes can be reduced and the suppression of the high-order mode frequency band can be improved by combining the three structures above. As shown in FIG. 7, a dielectric waveguide filter with four layers of resonant cavities will be explained as an example.

It should be noted that only the topological structure of a resonant cavity shown in FIG. 7 will be described below. Of course, other topological structures may also be adopted, and the specific structure needs to be determined according to the design requirements of the dielectric waveguide filter.

Specifically, the four layers of resonant cavities include a first layer of resonant cavities 01, a second layer of resonant cavities 02, a third layer of resonant cavities 03 and a fourth layer of resonant cavities 04 from top to bottom, wherein the first layer of resonant cavities 01 include four first resonant cavities 10 which are sequentially connected, the second layer of resonant cavities 02 include four second resonant cavities 20 which are sequentially connected, the third layer of resonant cavities 03 include four first resonant cavities 10 which are sequentially connected, and the fourth layer of resonant cavities 04 include four second resonant cavities 20 which are sequentially connected.

The first layer of resonant cavities 01 and the fourth layer of resonant cavities 04 are located at the outermost layer and are used to connect with the input end and the output end respectively. In this way, the first resonant cavity 10, connected with the input end, in the first layer of resonant cavities 01 is the head resonant cavity 5h, and the second resonant cavity 20, connected with the output end, in the fourth layer of resonant cavities 04 is the tail resonant cavity 5e. In this way, the feed structure 30 is arranged on the head resonant cavity 5h and the tail resonant cavity 5e, thereby reducing the excitation of the second high-order modes B from the source by using the feed structure 30.

Meanwhile, each first resonant cavities 10 in the first layer of resonant cavities 01, including the resonant cavity serving as the head resonant cavity 5h, cooperate with the second resonant cavities 20 in the second layer of resonant cavities 02 located in the middle layer through the window coupling structures formed by the first window coupling structures 10a and the second window coupling structures 20a in the embodiments above, to eliminate the coupling between the first high-order mode A in the first resonant cavities 10 and the first high-order mode A in the second resonant cavities 20. Similarly, the cross-layer adjacent resonant cavities between the second layer of resonant cavities 02 and the third layer of resonant cavities 03 as well as the cross-layer adjacent resonant cavities between the third layer of resonant cavities 03 and the fourth layer of resonant cavities 04 are also set the window coupling structures, wherein the fourth layer of resonant cavities 04, including the resonant cavity serving as the tail resonant cavity 5e, are also set the window coupling structures. In this way, the coupling between the first high-order modes A in the first resonant cavities 10 and the second resonant cavities 20 is eliminated by the window coupling structures described above.

The adjacent cavity coupling spacer bars 40 are arranged between the first resonant cavities 10 in the same layer and between the second resonant cavities 20 in the same layer, thereby reducing the coupling of the first high-order modes A and the second high-order modes B between two adjacent first resonant cavities 10 or between two adjacent second resonant cavities 20. The adjacent cavity coupling spacer bars 40 are also arranged between the first resonant cavity 10 serving as the head resonant cavity 5h and the adjacent first resonant cavity 10 in the same layer. Similarly, the adjacent cavity coupling spacers 40 are also arranged between the second resonant cavity 20 serving as the tail resonant cavity 5e and the adjacent second resonant cavity 20 in the same layer.

From the above analysis, it can be seen that the specific structure of a resonant cavity is related to its specific position and the connection relationship between the resonant cavity and other resonant cavities in the same layer and in adjacent layers.

Of course, there may be only one resonant cavity per layer, so for this topological structure, it is not necessary to arrange the adjacent cavity coupling spacer 40. Meanwhile, when a resonant cavity is not the head resonant cavity 5h or the tail resonant cavity 5e, it is no need to arrange the feed structure 30.

As can be seen from the embodiments above, in the dielectric waveguide filter provided by the present disclosure, the window coupling structures aiming at the first high-order modes A are set, which are composed of the first window coupling structures 10a arranged in each first resonant cavity 10 and the second window coupling structures 20a arranged in the corresponding second resonant cavities 20, and the first window coupling structures 10a and the second window coupling structures 20a are coupled to each other, reducing the inter-cavity coupling of the first high-order modes A of the two resonant cavities connected between two adjacent layers, so as to realize the suppression of the first high-order modes A.

The coupling, between the first windows 11 and the third windows 21 which are arranged at the positions where the magnetic field distribution of the first high-order modes A in FIG. 2b is the weakest (A1) and the magnetic field of the fundamental modes is the strongest, forms magnetic coupling to reduce the coupling between the first high-order modes A of the upper resonant cavities and the lower resonant cavities.

The coupling, between the second windows 12 and the fourth windows 22 corresponding to the positions where the electric field distribution in FIG. 2 is the strongest (A2), increases the electrical coupling of the first high-order modes A, thereby counteracting the magnetic coupling formed between the first windows 11 and the third windows 21, further reducing the inter-cavity coupling of the first high-order modes A, inhibiting the transmission of the first high-order modes A, and thus achieving the purpose of improving the suppression of the first high-order modes A by the filter.

In the present disclosure, the first windows 11 and the third windows 21 which are arranged in pairs may reduce the coupling between the high-order modes while maintaining the coupling of the main modes. Further, since the positions of the first window coupling structures 10a and the second window coupling structures 20a correspond to the positions of the distribution intensity of the electric field and the magnetic field of the first high-order modes A, thus the coupling of the first high-order modes A may be reduced in a targeted manner.

The feed structure 30 of the present disclosure reduces the excitation of the second high-order modes B from the source, thereby increasing the suppression of the second high-order modes B. The adjacent cavity coupling spacer 40 may reduce the coupling between the first high-order modes A and the first high-order modes B between two adjacent resonant cavities in the same layer.

Further, the combination of the feed structure 30, the window coupling structures formed by the first window coupling structures 10a and the second window coupling structures 20a, and the adjacent cavity coupling spacer 40 may suppress the first high-order modes A and the second high-order modes B simultaneously, so that the suppression of the high-order modes may be comprehensively improved and the harmonic frequency of the dielectric waveguide filter may be pushed farther.

The plurality of first resonant cavities 10 are arranged in a center symmetric or axisymmetric manner to form the upper resonant cavities, and the plurality of second resonant cavities 20 are arranged in the same manner as the arrangement of the upper resonant cavities to form the lower resonant cavities. Structural symmetry may reduce the coupling of the first high-order mode A and the second high-order mode B in the same resonant cavity, so as to further improve the far-end suppression effect.

The foregoing embodiments are only preferable embodiments of the present disclosure and are not for limiting the present disclosure. Any modifications, equivalent substitutions, improvements and the like in accordance with the spirit and principles of the present disclosure should fall within the protection scope of the present disclosure.

1. A dielectric waveguide filter, comprising:
a plurality of first resonant cavities and a plurality of second resonant cavities, wherein each two of the plurality of first resonant cavities are connected to form upper resonant cavities, each two of the plurality of second resonant cavities are connected to form lower resonant cavities;
the first resonant cavity having a first window coupling structure, wherein the first window coupling structure comprises: at least one of a first window opened in the surface of the first resonant cavity and a second window opened in the surface of the first resonant cavity;
the second resonant cavity having a second window coupling structure corresponding to the first window coupling structure, wherein the second window coupling structure comprises: at least one of a third window opened in the surface of the second resonant cavity and a fourth window opened in the surface of the second resonant cavity.

2. The dielectric waveguide filter according to claim 1,
wherein the upper resonant cavities and the lower resonant cavities are correspondingly overlapped.

3. The dielectric waveguide filter according to claim 1,
wherein the first window coupling structure and the second window coupling structure cooperate to eliminate coupling between the first high-order mode in the first resonant cavity and the first high-order mode in the second resonant cavity.

4. The dielectric waveguide filter according to claim 1,
wherein the first window is opened in the surface of the first resonant cavity at a position where the magnetic field distribution of a first high-order mode in the first resonant cavity is the weakest, and
wherein the second window is opened in the surface of the first resonant cavity at a position where the electric field distribution of the first high-order mode in the first resonant cavity is the strongest.

5. The dielectric waveguide filter according to claim 1,
wherein the third window is opened in the surface of the second resonant cavity at a position where the magnetic field distribution of a first high-order mode in the second resonant cavity is the weakest, and
wherein the fourth window is opened in the surface of the second resonant cavity at a position where the electric field distribution of the first high-order mode in the second resonant cavity is the strongest.

6. The dielectric waveguide filter according to claim 1,
wherein each resonant cavity of the dielectric waveguide filter is solid cavity filled with a dielectric.

7. The dielectric waveguide filter according to claim 1, wherein, the first window and the second window are located on a side surface, opposite to the second resonant cavity, of the first resonant cavity; and
the third window and the fourth window are located on a side surface, opposite to the first resonant cavity, of the second resonant cavity.

8. The dielectric waveguide filter according to claim 7, wherein, the first window is located at a center of a pair of opposite sides of the first resonant cavity, and the third window is located at a center of a pair of opposite sides of the second resonant cavity; and
the second window is flush with a center of the first resonant cavity and is ¼ of a side length away from the center of the first resonant cavity, and the fourth window is flush with a center of the second resonant cavity and is ¼ of a side length away from the center of the second resonant cavity.

9. The dielectric waveguide filter according to claim 1, wherein, further comprises: a feed structure for reducing the excitation of a second high-order mode, wherein the feed structure comprises:
protrusions, protruding from one side edge of the first resonant cavity or the second resonant cavity to the outside of the cavity; and
feed posts, arranged at the junctions of the first resonant cavity or the second resonant cavity and the protrusions.

10. The dielectric waveguide filter according to claim 9, wherein the feed posts are arranged in resonant cavities and allow feeding structures between the upper resonant cavities and the lower resonant cavities to be connected by penetrating through the upper and lower surfaces of the resonant cavities.

11. The dielectric waveguide filter according to claim 9, wherein, the protrusions comprise:
a first protrusion, protruding from one side edge of the first resonant cavity as an input cavity to the outside of the cavity; and
a second protrusion, protruding from one side edge of the second resonant cavity as an output cavity to the outside of the cavity.

12. The dielectric waveguide filter according to claim 1, wherein, further comprising:
adjacent cavity coupling spacer, connected between two adjacent first resonant cavities or between two adjacent second resonant cavities.

13. The dielectric waveguide filter according to claim 12,
wherein the adjacent cavity coupling spacer is located at the center of a pair of opposite sides of the two first resonant cavities or the two second resonant cavities to reduce the coupling of the first high-order modes and the second high-order modes between the two adjacent first resonant cavities or between the two adjacent second resonant cavities.

14. The dielectric waveguide filter according to claim 12, wherein, the adjacent cavity coupling spacer does not coincide with the first windows or the third windows in position.

15. The dielectric waveguide filter according to claim 1, wherein, the plurality of first resonant cavities are arranged in a center symmetric or axisymmetric manner to form the upper resonant cavities, and
the plurality of second resonant cavities are arranged in the same manner as the arrangement of the upper resonant cavities to form the lower resonant cavities.
